(19) United States
(12) Patent Application Publication
(10) Pub. No.: US 2005/0066224 A1
(43) Pub. Date: Mar. 24, 2005

(54) Method and device for correcting errors in a digital memory

(75) Inventors: Mario Di Ronza, Munchen (DE); Alexander Olbrich, Hohenbrunn (DE)

Correspondence Address: Maginot, Moore & Beck, Bank One Tower, Suite 3000, 111 Monument Circle, Indianapolis, IN, 46204, US

(73) Assignee: Infineon Technologies AG, Munchen (DE)

(21) Appl. No.: 10/901,927

(22) Filed: Jul. 29, 2004

(30) Foreign Application Priority Data
Jul. 29, 2003 (DE) 103 34 520.5

(51) Int. Cl. G06F 11/00

(52) U.S. Cl. 714/5

(57) ABSTRACT

A correcting device (6) with substitute memory words (8) which take on the function of memory words identified as defective in the memory (1) is assigned for correcting the errors of a digital memory (1). Memory access to memory words of the memory (1) identified as defective is for this purpose diverted to corresponding substitute memory words (8). According to the invention the memory (1) has different lines (2, 3) for reading and for writing, wherein when there is write access a value written into a memory word via an input line (2) is read out again and appears on the output line (3) (write-through memory). Each time there is write access to a memory word of the memory (1) the written value is compared with the value output via the output line (3) and if there is incorrect agreement the corresponding memory word is identified as defective. In this way error correction can take place during normal operation of the memory (1) (at-speed correction), no checking of the memory word being necessary at the start. Each memory word of the memory (1) is checked each time there is write access and, if applicable, identified as defective, whereupon the error can be corrected with the aid of a substitute memory word (8).

The present invention relates to a method for correcting errors in a digital memory with individually addressable memory words and also a memory device set up for executing the method.

For correcting errors in a digital memory with individually addressable memory words it is known to assign to each memory word additional bits in which items of test information on the value filed in the memory word in each case are stored, with the help of which information an error in the write/read process can be identified to the specific memory word and if necessary also eliminated. Disadvantageously this procedure requires a large additional amount of memory, as additional bits have to be assigned to each memory word in the memory.

Besides this, it is also known to assign to a digital memory a few substitute memory words which, if required, can take on the function of individual memory words identified as defective. For this purpose at the start of operation a value is written into each memory word on a trial basis and then read out again and compared with the written value. If there is incorrect agreement the address of the memory word in question is stored in a defective word memory. As soon as there is access in normal operation to a memory word the address of which is stored in the defective word memory, the write access or the read access is diverted to a substitute memory word. Advantageously this method requires only a small additional memory space. However, this method has the disadvantage that it can identify and eliminate only errors which have been established during checking at the start. Errors occurring during operation cannot be identified or eliminated with this method.

The object of the present invention is to create a method for correcting errors in a digital memory and also a memory device of the initially mentioned kind set up for executing the method, wherein errors of the digital memory can also be identified and eliminated during operation and no checking is necessary at the start.

According to the invention this object is achieved by a method with the features of claim 1 or a memory device with the features of claim 10.

According to the present invention a digital memory is used in which when there is a write access to a memory word this memory word is also read out and the read value is output via a separate output line. This functionality is also designated as write-through capability and makes it a condition that the memory has separate input lines and output lines for the data. In this case a value written via the input lines is immediately output again on the output line, wherein, using the value output on the output line, it is already possible to establish whether the value in the memory word in question has been correctly stored or the memory word in question is operating correctly. Errors in the memory words can thus already be established during writing. According to the invention when there is a write process to a specific memory word the value input on the input line can be compared with the value simultaneously output on the output line and if there is incorrect agreement the memory word in question is identified as incorrect. This has the advantage that monitoring of the individual memory words can be carried out in a word processing device during normal operation of the memory and errors can already be identified during writing, even before there is read access to the incorrect value.

Advantageously memory words identified as incorrect are marked in that their addresses are stored in a defective word memory. Access to memory words identified as defective can therefore be diverted in that monitoring takes place in an address comparator as to whether in the memory a memory word is to be accessed with an address which is stored in the defective word memory and thus has been identified as defective. In this case access can be diverted to a previously established substitute memory word. As with the memory words of the memory it can in this case be provided that write access to the corresponding substitute memory word takes place via a different line from the read access to the corresponding substitute word. Advantageously, for read access a multiplexer is used which forwards either the output signal of the memory or the output signal of the substitute memory words, in order thus to be able to divert the read access. A multiplexer is not required for write access in most cases, as the value to be written can be applied simultaneously to both the memory and the substitute memory words, as for effective storing of the applied value a further signal is almost always required in any case, which is conducted optionally to a memory word identified as non-defective in the memory or to a substitute memory word if there is an attempt to access in the memory a memory word identified as defective.

Various strategies can be pursued for storing the addresses of memory words identified as defective in a defective word memory. On the one hand the address of a memory word identified as defective can remain permanently stored for the operating life of the memory. The function of a memory word identified as defective in a case of this kind is not checked again as soon as its address has once been stored in the defective word memory. This requires little space and creates increased security, as the memory words are taken out of operation as soon as they have once shown a fault. This procedure can also be designated as static error correction.

Besides this, dynamic error correction is also possible, in which the addresses of memory words identified as defective can also be deleted again in the defective word memory. This happens in particular if the memory word in question is functioning correctly again. In this way account can be taken of the circumstance that the malfunctioning of a memory word can also pass if it was caused by changing environmental influences, for example. This may be, for example, too low or too high a temperature or too low or too high an operating voltage. In a case of this kind as soon as the temperature, the operating voltage or the environmental influence decisive for the malfunction is again in the range in which the memory word functions correctly, the address of the corresponding memory word in the defective word memory can be deleted again and the memory word can continue to be used. Therefore a smaller number of substitute memory words is sufficient, as a substitute memory word is not used unnecessarily to replace a memory word which has only temporarily shown a malfunction.

The method according to the invention is advantageously executed in a word processing device during normal operation of the memory device, each time there is write access to a memory word its function being checked and, if applicable, the function of a memory word identified as defective being transferred to a substitute memory word. In this way at the start of operation basically no systematic checking of all the memory words is necessary, as the memory words are automatically checked when they are used or when first write accessed. However, it is nevertheless possible before operation of the memory to check a few or all the memory words systematically, in order to ascertain the number of defective memory words in advance. If the number exceeds a certain limit and in particular the number of substitute memory words available, errorless functioning can no longer be guaranteed in spite of error correction.

Basically a signal can be emitted as soon as a memory word is identified as defective. This signal can be used, for example, possibly to take counter-measures, such as increasing a supply voltage reduced to lessen current consumption, for example. It is further possible to evaluate how many of the existing substitute memory words are already being used, in order to be able to react on time, before there are no more substitute memory words available. This method is to be recommended in particular for static error correction in which the addresses of memory words identified as defective are no longer deleted in the defective word memory.

The invention is explained in greater detail below using a preferred embodiment example and referring to the attached drawing.

The figure shows the construction of a memory device with error correction according to the invention.

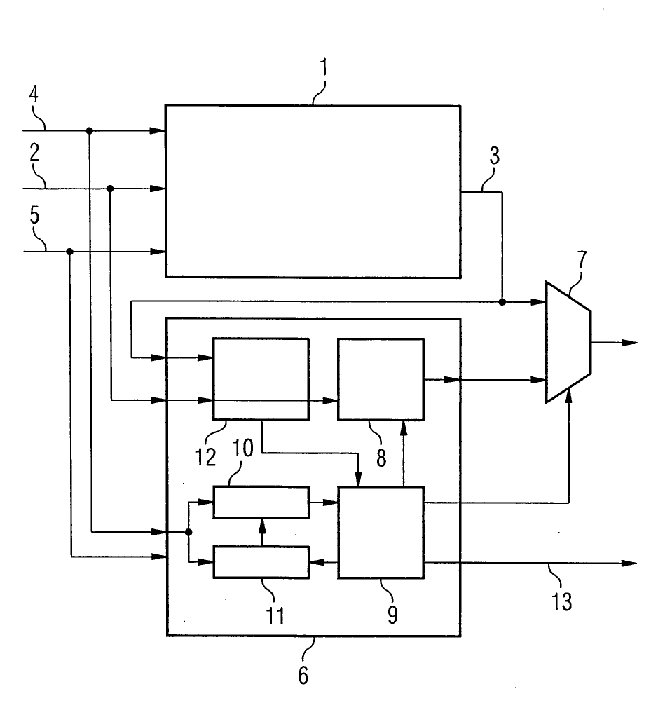

In FIG. 1 in the memory arrangement a digital memory 1 with individually addressable memory words is illustrated. The individual memory words can have any number of bits, which are jointly addressed, however. The memory 1 has input lines 2 for writing the data into the memory words and output lines 3 for reading out the data from the memory words. The memory words are addressed via address lines 4. Further provided are control lines 5, with which the write or read process of the memory 1 can be controlled.

Assigned to the memory 1 is an error correcting device 6, which is connected to all the lines 2 to 5 leading into the memory 1 or leading out of it. Applied to the correcting device 6 are thus the address applied to the memory 1, a value to be written into the addressed memory word, a value read out from an addressed memory word and the control lines for the memory 1.

The memory 1 has a write-through capability, i.e. a value written into an addressed memory word via the input line 2 appears on the output line 3. The value is then passed through the addressed memory word in such a way that the value applied to the output line 3 corresponds to the value applied to the input line 2 only if the memory word is functioning properly.

The correcting device 6 has an error detector 12, to which the input signal of the input line 2 and the output signal of the output line 3 are applied. The correcting device 6 further has a control device 9 which controls all the components within the correcting device 6. The control device 9, for example, triggers the error detector 12 in such a way that each time there is a write process to the memory 1 the error detector 12 compares the value written via the input line 2 with the value output via the output line 3 and if there is a difference between the two values emits a signal to the control device 9. In this case the control device 9 triggers a defective word memory 11 within the correcting device 6 in such a way that the address applied at the time is taken on as a new entry. This causes the address of a memory word in the memory 1 to be stored as a new entry in the defective word memory 11 as soon as the memory word is identified as defective in that a discrepancy is detected between the written value and the output value.

The correcting device 6 further has an address comparator 10, to which on the one hand the address signal of the memory 1 and on the other hand the addresses of the entries in the defective word memory 11 are applied. The address comparator 10 emits a signal to the control device 9 as soon as an address which is stored in an entry in the defective word memory 11 is applied to the memory 1, so the control device 9 receives a signal as soon as there is to be access in the memory 1 to a memory word identified as defective. In this case the control device 9 ensures that access is diverted to a substitute memory word in a substitute word memory 8. If this access is a write access, the value to be written applied to the input line 2 and looped through the error detector 12 to the substitute word memory 8 is written into a corresponding substitute memory word. The address of the substitute memory word within the substitute word memory 8 can advantageously correspond to the address under which the address which has led to agreement in the address comparator 10 is stored in the defective word memory 11. If it is a read access the substitute word memory 8 is triggered by the control device 9 in such a way that the corresponding memory word outputs the requested value on a multiplexer 7. The control device 9 simultaneously triggers the multiplexer 7 in such a way that instead of the signal on the output line 3 of the memory 1 it emits the output signal of the substitute word memory 8. The device illustrated in the figure is accordingly illustrated from the outside as a completely normal memory in which data can be read in via one line and data read out via another line.

Within the error correction 6 the output of the substitute word memory 8 is likewise connected to the error detector 12, so the error detector 12 can also identify errors within the substitute cell memory 8. The substitute word memory 8, like the memory 1, has write-through capability, so an error can already be identified during writing into a substitute memory word within the substitute word memory 8.

The control device 9 within error correction 6 further delivers an error signal 13, by which various states can be indicated. For example, by means of the error signal 13 it is possible to indicate whether a certain number of addresses of memory words identified as defective are stored in the defective word memory 11. As the number of memory places in the defective word memory is almost always equal to the number of substitute memory words, in this way it is possible to communicate how many substitute memory words are still available. The signal 13 can preferably be set up in such a way that it indicates when there is no longer a substitute memory word available and thus the error correction cannot correct any more additional errors. Besides this, it is also conceivable that a signal is output every time via the signal line 13 as soon as a memory word in the memory 1 or a new memory word in the memory 1 is identified as defective.

1-11. (canceled)

12. A method of correcting errors in a digital memory including individually addressable memory words comprising:
write accessing a memory word in a digital memory by an input line to the digital memory;
performing a write operation on the memory word in the digital memory via the input line using a first value;
outputting on an output line from the digital memory a second value obtained from the memory word, wherein the output line is a line different from the input line;
comparing the first value to the second value at about the same time as performing the write operation;
identifying the memory word as defective if based on the comparison the first value is different from the second value; and
diverting access to the memory word in the digital memory to a substitute word memory if the memory word in the digital memory is identified as defective.

13. The method of claim 12, wherein the memory word has an address, further comprising:
storing the address of the memory word identified as defective in a defective word memory.

14. The method of claim 13, comprising:
maintaining the stored address in the defective word memory throughout an operating life of the digital memory.

15. The method of claim 13, further comprising:
providing the address of the memory word to which a value is to be written;
determining if the memory word address is stored in the defective word memory; and
deleting the memory word address from the defective word memory if based upon the comparison the value written to the digital memory is the same as the read value output from the digital memory and if the memory word address is stored in the defective word memory.

16. The method of claim 12, wherein the step of write accessing comprises:
generating write access using a control unit assigned to the digital memory.

17. The method of claim 12, wherein:
the step of write accessing comprises write accessing the digital memory in a word processing device;
the step of comparing comprises comparing the first value to the second value at about the same time as the write operation step during normal operations of the word processing device; and
the step of identifying comprises identifying the memory word in the digital memory as defective during normal operations of the word processing device if based on the comparison the first value is different from the second value.

18. The method of claim 12, wherein the step of identifying comprises:
generating an error signal for each memory word in the digital memory identified as defective.

19. The method of claim 12, further comprising:
establishing a threshold;
counting the number of memory words in the digital memory identified as defective; and
generating an indication if the number of memory words in the digital memory identified as defective exceeds the threshold.

20. The method of claim 12, wherein the diverting step further comprises:
write accessing a memory word in the substitute word memory by an input line of the substitute word memory;
performing a write operation on the memory word in the substitute word memory using the first value;
outputting on an output line from the substitute word memory a third value obtained from the memory word of the substitute word memory, wherein the output line of the substitute word memory is a line different from the input line of the substitute word memory;
comparing the first value to the third value at about the same time as performing the write operation step on the memory word in the substitute word memory;
identifying the memory word in the substitute word memory as defective if based on the comparison of the first value to the third value the first value is different from the third value.

21. A memory device comprising:
a digital memory having individually addressable memory words;
a write access input line operably connected to the digital memory;
an output line separate from the input line and operably connected to the digital memory;
a substitute memory; and
a correcting device operably connected to the write access input line and the output line and programmed to
compare a first value provided on the write access input line to be written in a memory word of the digital computer with a second value read from the memory word of the digital memory to determine if the first value matches the second value, and
identify the memory word as defective if the first value does not match the second value.

22. The device of claim 21, wherein the correcting device is further programmed to cause the first value to be written in a memory word of the substitute word memory when the memory word of the digital computer is identified as defective.

23. The device of claim 21, the correcting device further comprising:
a defective word memory for storing word memory addresses identified by the correcting device as defective; and
an address comparator operatively connected to the write access input line and the defective word memory, such that memory word addresses on which write operations of first values are to be performed are compared to the stored word memory addresses in the defective word memory and matches are identified.

24. A digital memory device with memory words comprising:
a write access input line for providing input values to an addressed memory word;
a digital memory with a write through capability operably connected to the write access input line and operable to perform write operations using the input values on the addressed memory word and to write through the stored values in the memory word to an output;
an output line, separate from the write access input line, operably connected to the digital memory output to receive the values output from the digital memory;
a comparator operably connected to the write access input line and the output line to compare the input values to the output values;
a substitute memory operably connected to the address comparator; and
a control device operably connected to the substitute memory and the comparator and programmed to store the input values to the substitute memory when the input values do not match the output values.

25. The digital memory device of claim 24, further comprising:
an address line operably connected to the digital memory to identify the memory word address on which write operations are performed using the input values; and
a defective word memory operably connected to the control device, wherein the control device is programmed to store the address of the memory word on which the write operation was performed using input values when the input values do not match the output values.

26. The digital memory device of claim 25, further comprising:
an address comparator operably connected to the address line and the defective word memory to compare the address of memory words on which write operations are to be performed using the input values with the address of the defective memory words stored in the defective word memory, wherein the control device is programmed to store the input values to the substitute memory when the address comparator identifies a match between the address of the memory word on which write operations are to be performed using the input values and the address of the memory word stored in the defective word memory.

27. The digital memory device of claim 26, wherein the control device is further programmed to delete the memory word address stored in the defective word memory when
the address comparator identifies a match between the address of a memory word on which write operations are to be performed using the input values and the address of the memory word stored in the defective word memory, and
the input values match the output values.

28. The digital memory device of claim 26, further comprising a multiplexer controlled by the control device and operably connected to the output line of the digital memory and an output line from the substitute memory; wherein:
the address comparator is operably connected to the address line and the defective word memory to compare the address of a memory word from which stored values are to be read accessed with the address of the defective memory words stored in the defective word memory; and
the control device is programmed to set the multiplexer to the digital memory output line when the address comparator does not identify a match between the address of the memory word to be read accessed and the address of the memory word stored in the defective word memory, and is programmed to set the multiplexer to the substitute memory output line when the address comparator identifies a match between the address of the memory word to be read accessed and the address of a memory word stored in the defective word memory.

29. The digital memory device of claim 25, further comprising:
an address comparator operably connected to the address line and the defective word memory to compare the address of memory words on which write operations are performed using the input values with the address of the defective memory words stored in the defective word memory, wherein the control device is programmed to store the input values to the substitute memory when the address comparator identifies a match between the address of the memory word on which write operations are performed using the input values and the address of the memory word stored in the defective word memory.

30. The digital memory device of claim 29, wherein the control device is further programmed to delete the memory word address stored in the defective word memory when
the address comparator identifies a match between the address of a memory word on which write operations are performed using the input values and the address of the memory word stored in the defective word memory, and
the input values match the output values.

31. The digital memory device of claim 29, further comprising a multiplexer controlled by the control device and operably connected to the output line of the digital memory and an output line from the substitute memory; wherein:
the address comparator is operably connected to the address line and the defective word memory to compare the address of a memory word from which stored values are to be read accessed with the address of the defective memory words stored in the defective word memory; and
the control device is programmed to set the multiplexer to the digital memory output line when the address comparator does not identify a match between the address of the memory word to be read accessed and the address of the memory word stored in the defective word memory, and is programmed to set the multiplexer to the substitute memory output line when the address comparator identifies a match between the address of the memory word to be read accessed and the address of a memory word stored in the defective word memory.
